(19) United States
(12) Patent Application Publication
(10) Pub. No.: US 2021/0112721 A1
(43) Pub. Date: Apr. 22, 2021

(54) CANNABIS HARVESTER AND METHODS OF USING THE SAME

(71) Applicant: JB Engles LLC, Lake Crystal, MN (US)

(72) Inventors: Jay Engles, Lake Crystal, MN (US); Brian Engles, Lake Crystal, MN (US)

(21) Appl. No.: 17/038,888

(22) Filed: Sep. 30, 2020

Related U.S. Application Data
(63) Continuation of application No. 62/909,032, filed on Oct. 1, 2019.

(51) Int. Cl. A01D 45/16; A01D 69/00; A01D 91/00; A01D 61/00

(52) U.S. Cl. CPC A01D 45/16; A01D 69/002; A01D 34/44; A01D 61/008; A01D 61/002; A01D 91/00

(57) ABSTRACT

Systems and methods for mechanical Cannabis harvesting which utilize a harvester having two counter-rotating rollers, each having a brush thereon, where the brushes serve to strip leaves and buds from the stalk of a standing Cannabis plant introduced to a harvesting space between them. The brushes transport the stripped leaves and buds to a series of conveyors that eventually deposit the leaves and buds in a hopper. The stripped stalk of the Cannabis plant may be left standing in the field to be cut down later, or may be knocked or cut down by the harvester.

### CROSS-REFERENCE TO RELATED APPLICATIONS

This application claims the benefit of U.S. Provisional Patent Application Ser. No. 62/909,032, filed Oct. 1, 2019, the entire disclosure of which is herein incorporated by reference.

### BACKGROUND OF THE INVENTION

### 1. Field of the Invention

This disclosure is related to the field of harvesting agricultural products. More particularly, this disclosure is related to a mechanized apparatus for harvesting Cannabis (or other crops) and methods of using the same.

### 2. Description of the Related Art

Humans have used agricultural machinery for hundreds of years. Some historians credit Jethro Tull, who built his first horse-drawn seed drill in the early 1700s, with the advent of mechanized agriculture. Mechanized agriculture has greatly improved the productivity of farm workers over the years. Ever since the beginning of the Industrial Revolution, powered machinery has replaced many farm jobs formerly carried out by manual laborers or by working animals such as oxen, horses, and mules.

Modern mechanized agriculture includes the use of tractors, trucks, combine harvesters, countless types of farm implements, airplanes and helicopters (for aerial application), and other vehicles. Precision agriculture even uses computers in conjunction with satellite imagery and/or satellite navigation to increase yields. Typically, machines used in agriculture either will be standalone or may work in conjunction with another machine, such as a tractor. For example, standalone machines include combines, which are designed to reap, thresh, and winnow crops. Typical crops that may be harvested using a combine include wheat, oats, rye, barley, corn (maize), sorghum, soybeans, flax (linseed), sunflowers, and canola.

One agricultural crop that has not greatly benefited from mechanized agriculture is Cannabis, also known in the United States as marijuana. Cannabis has been used therapeutically and recreationally for thousands of years. The first descriptions of medical uses for Cannabis date from the first century A.D. in Chinese herbal texts. Some evidence exists that medical Cannabis may be used to reduce nausea and vomiting, for example, during chemotherapy; improve appetite in people, for example, for those with HIV/AIDS; reduce chronic pain and muscle spasms; and treat severe forms of epilepsy. It has also been suggested or theorized that medical Cannabis may be used to treat conditions including female cramps, anxiety, inflammation, pain, insomnia, irritable bowel disease, dementia, Parkinson's, seizures, multiple sclerosis, glaucoma, arthritis, and migraines, as well as other conditions. However, in the United States, most or all forms of Cannabis have been illegal under federal laws since the 1970s. As such, the processes for mechanizing the harvesting of Cannabis stagnated long ago.

Cannabis is a genus of flowing plants in the family Cannabaceac. Some consider that the genus includes three species: Cannabis sativa, Cannabis indica, and Cannabis ruderalis. Others consider the above species to be subspecies of a single species, Cannabis sativa. In any case, as used herein, all forms of Cannabis are intended to be include in the scope of the term “Cannabis.” In the United States and as used herein, “hemp” is a form of Cannabis that produces very low amounts of the psychoactive chemical compound THC, and is often harvested for the fibrous material that comprises portions of its stalk. Said another way, referring to a Cannabis plant as hemp indicates the intended use of the plant will likely be the creation of hemp fibers. After harvesting, the fibers may be spun into useable fibers or fibrous materials.

Cannabis has been harvested in the United States for nearly 20 years, but the harvesting has only been for hemp. Specifically, the commercial hemp industry has harvested Cannabis plants in the United States in recent years as the regulations on hemp have become more favorable for growing hemp but not for growing recreational Cannabis. Typically, smallholder plots of hemp were harvested by hand. The hemp plants are cut at a point on the stalk that is just above the soil and left on the ground to dry. Mechanical harvesting of hemp is now common for larger plots, typically using specially adapted cutter-binders or simpler cutters. The cut hemp may be laid in swathes to dry for a period of time, sometimes for several days. This drying process is typically followed by retting, either water retting (the collected hemp floats in water) or dew retting (the hemp remains on the ground and is affected by the moisture in dew and by mold and bacterial action). In these cases, the entire hemp plant (or portions thereof) may subsequently be processed to obtain the hemp fibers.

Cannabis plants typically include the following components: (a) an underground root system; (b) a large, central stalk that rises from the root system to nearly the upper tip of the plant; (c) a collection of leaves that branch from the stalk; and (d) collections of flowers, which collections may be referred to as “buds.” In some cases, as a Cannabis plant matures, the leaves that branch from the central stalk may turn into portions of stalk, which portions may sprout leaves and buds. The commercial hemp industry is typically interested in the stalks of the Cannabis plant because the stalks contain bast fibers that may be used to make fibers or fibrous materials. The commercial recreational and medicinal Cannabis industry, on the other hand, is typically interested in the buds and leaves of the Cannabis plant because these portions of the plant are typically the richest in chemical compounds of interest.

As discussed above, there are different uses for the different parts of the Cannabis plant, including the hemp forms of Cannabis. For example, the upper parts of the Cannabis plant are typically filled with leaves, buds, and seeds, while the lower part of the plant is typically a majority stalk. In some mechanized harvesting processes used to harvest hemp, the upper part of the plant may be cut from the lower part using a specially designed hemp harvester. Such hemp harvesters may include a first mechanized cutter, a second mechanized cutter, a conveyer, and a collector. The first mechanized cutter may be used to cut the upper part of the hemp plant from the lower stalk. The conveyer may then catch the cut upper parts and convey them up and into the collector. Meanwhile, the second mechanized cutter may cut the stalks near the ground and allow the stalks to fall to the ground to dry and ret. The collected upper parts of the hemp plant may then be processed further. For example, the seeds may be processed into a more useable form and the buds and leaves may be pressed for the oils found therein. There are many different ways that either part of a hemp plant may be alternatively or further processed.

More recently, with the advent of medical and recreational Cannabis in the United States. Cannabis farmers have become more interested in collecting intact buds and leaves of Cannabis plants. Again, this is because these are the portions of the plants that typically contain the highest concentrations of the psychoactive and medicinal chemicals found within Cannabis, including the aforementioned THC, as well as CBD, a chemical that may also have many useful medical properties.

Traditional mechanized agricultural methods of harvesting Cannabis may have several problems when endeavoring to harvest Cannabis for its buds and leaves. First, many traditional processes cut the whole plant from the ground and leave the plant to dry and then ret. These processes tend to damage and taint the buds and leaves, leaving the farmer with an unsellable product. This is not an issue for most hemp harvests, but can be very detrimental for harvesting recreational Cannabis. Other methods remove the upper portions of the Cannabis plant in total, but these methods are typically inefficient because they collect too much of the Cannabis plant, including the upper portions of the unwanted stalk. Hand harvesting Cannabis is sometimes preferred to these methods because laborers can selectively harvest only the buds and/or leaves, or at least minimal portions of the stalk. Further, the laborers may keep the buds and/or leaves clean during the harvesting process so that the end product is more aesthetically pleasing to the consumer. However, hand harvesting is too expensive and time consuming to be conducted on an industrial scale.

### SUMMARY OF THE INVENTION

The following is a summary of the invention, which should provide to the reader a basic understanding of some aspects of the invention. This summary is not intended to identify critical elements of the invention or in any way to delineate the scope of the invention. The sole purpose of this summary is to present in simplified text some aspects of the invention as a prelude to the more detailed description presented below.

Because of these and other problems in the art there are provided herein systems and methods for mechanical Cannabis harvesting which utilize a harvester having two counter-rotating rollers, each having a brush thereon, where the brushes serve to strip leaves and buds from the stalk of a standing Cannabis plant introduced to a harvesting space between them. The brushes transport the stripped leaves and buds to a series of conveyors that eventually deposit the leaves and buds in a hopper. The stripped stalk of the Cannabis plant may be left standing in the field to be cut down later, or may be knocked or cut down by the harvester.

Described herein, among other things, is a Cannabis harvester comprising: a first roller having a brush thereon, the first roller rotating in a first direction and having a first harvester conveyor associated therewith; a second roller having a brush thereon, the second roller rotating in a second direction opposing the first direction and having a second harvester conveyor associated therewith; a collecting conveyor configured to collect material from at least one of the first harvester conveyor and the second harvester conveyor and transport the material to a hopper; and a collector support configured to support the hopper.

In an embodiment, the harvester further comprises a coupler for connecting the harvester to a vehicle.

In an embodiment of the harvester, the vehicle is a tractor.

In an embodiment of the harvester, the coupler is a three point mount coupler.

In an embodiment of the harvester, the coupler is a ball mount coupler.

In an embodiment of the harvester, the vehicle is a combine.

In an embodiment of the harvester, the first roller, the second roller, the first harvester conveyor, the second harvester conveyor, and the collecting conveyor are powered by a Power-Take-Off (PTO) from the vehicle.

In an embodiment of the harvester, the first roller and the second roller are within an enclosure.

In an embodiment of the harvester, the first harvester conveyor and the second harvester conveyor are within the enclosure.

In an embodiment of the harvester, the first roller, the second roller, the first harvester conveyor, the second harvester conveyor, and the collecting conveyor are powered by a motor on the Cannabis harvester.

There is also described herein, in an embodiment, a method of mechanically harvesting Cannabis, the method comprising: introducing a standing Cannabis plant to a harvesting space, the harvesting space being located between a first roller having a brush thereon and a second roller having a brush thereon; rotating the first roller in a first direction; rotating the second roller in a second direction opposing the first direction; the rotating of the first roller and the second roller causing the brush on the first roller and the brush on the second roller to strip leaves and buds from a stalk of the Cannabis plant and deposit the leaves and buds onto at least one harvester conveyor; the at least one harvesting conveyor transporting the leaves and buds to a collecting conveyor, the collecting conveyor transporting the material to a hopper.

In an embodiment of the method, the stalk is left standing after the stalk is stripped of the leaves and buds.

In an embodiment of the method, the introducing is caused by a vehicle moving the first roller and the second roller to the standing Cannabis plant.

In an embodiment of the method, the vehicle is a tractor.

In an embodiment of the method, the vehicle is a combine.

In an embodiment of the method, the first roller, the second roller, the at least one harvester conveyor, and the collecting conveyor are powered by a Power-Take-Off (PTO) from the vehicle.

In an embodiment of the method, the harvesting space is within an enclosure.

### BRIEF DESCRIPTION OF THE DRAWINGS

FIG. 1 depicts a front perspective view of an embodiment of a Cannabis harvester as contemplated herein, which is connected to an exemplary tractor.

FIG. 2 depicts a rear view of the embodiment of the Cannabis harvester depicted in FIG. 1.

FIG. 3 depicts an additional front perspective view of the embodiment of the Cannabis harvester depicted in FIG. 1.

FIG. 4 depicts a front perspective view of an embodiment of a harvesting section of the embodiment of the Cannabis harvester depicted in FIG. 1.

FIG. 5 depicts additional details of the embodiment of a harvesting section of the embodiment of the Cannabis harvester depicted in FIG. 4.

FIG. 6 depicts additional details of the embodiment of a harvesting section of the embodiment of the Cannabis harvester depicted in FIG. 4 with the enclosure portion, brushes, and harvester conveyers removed.

FIG. 7 depicts additional details of the embodiment of a harvesting section of the embodiment of the Cannabis harvester depicted in FIG. 4 with the most of the enclosure portion, brushes, and harvester conveyers removed.

FIG. 8 depicts an alternative embodiment of a Cannabis harvester to that of FIG. 1. This embodiment is designed to have a pull type connection to the tractor and have its hydraulic pump run off the tractor's Power-Take-Off (PTO).

### DETAILED DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matters contained in the description or shown in the accompanying drawings shall be interpreted as illustrative and not in a limiting sense.

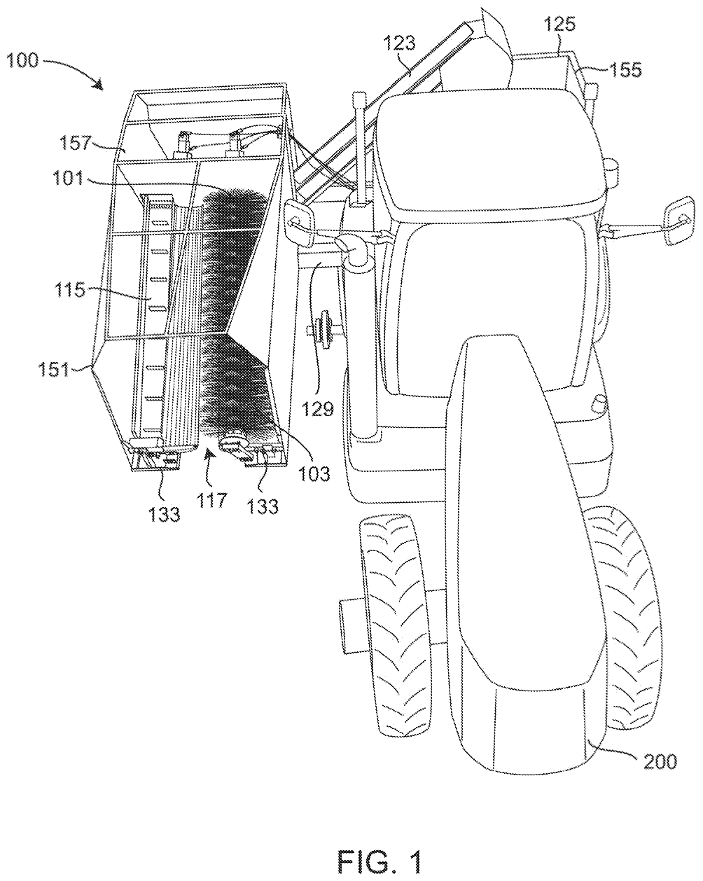

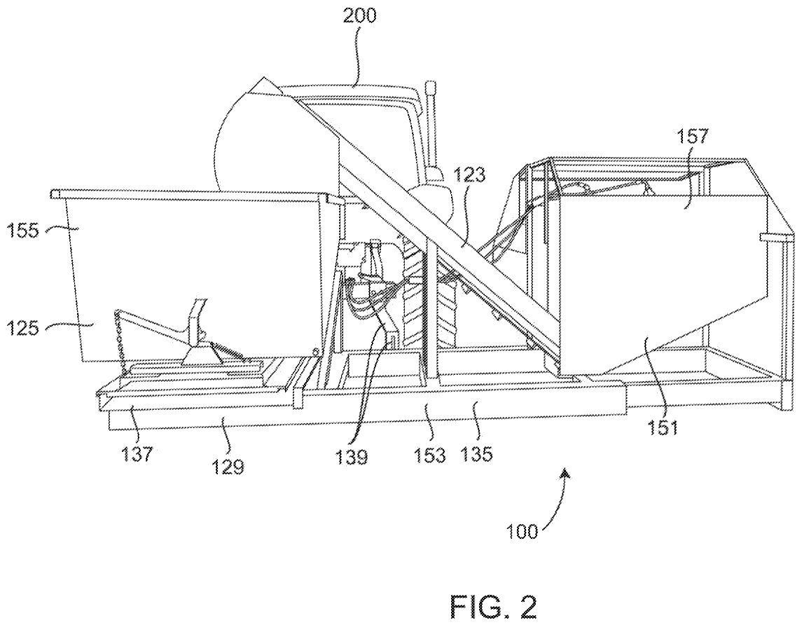

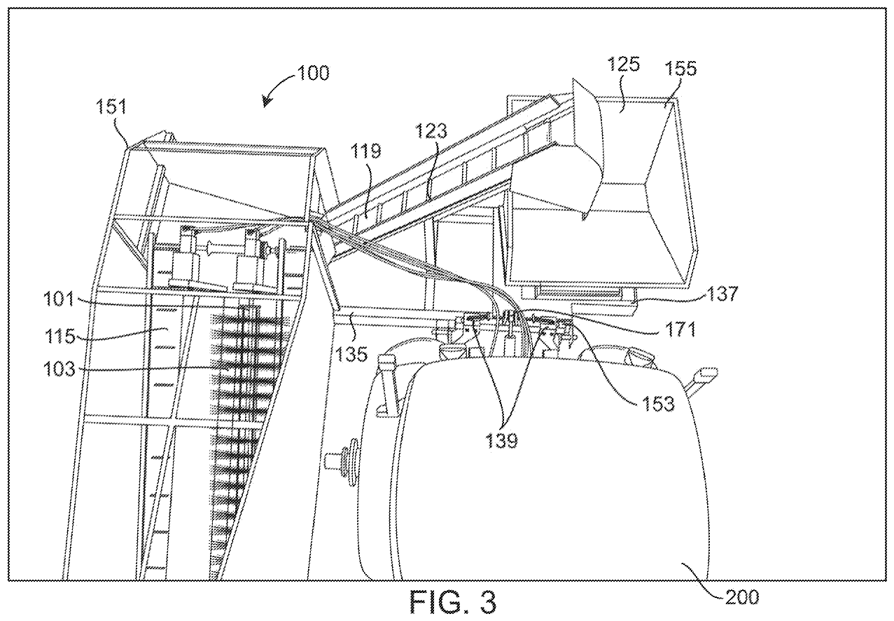

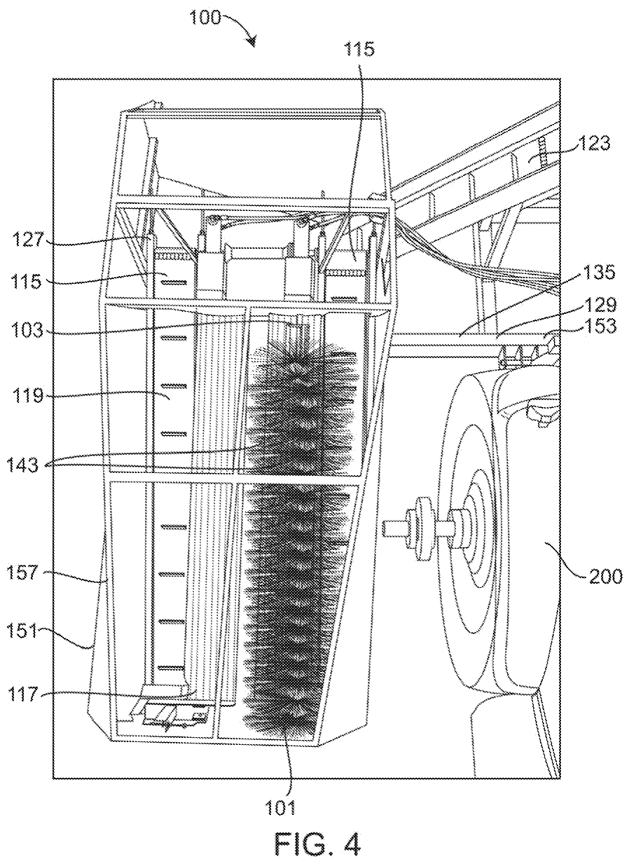

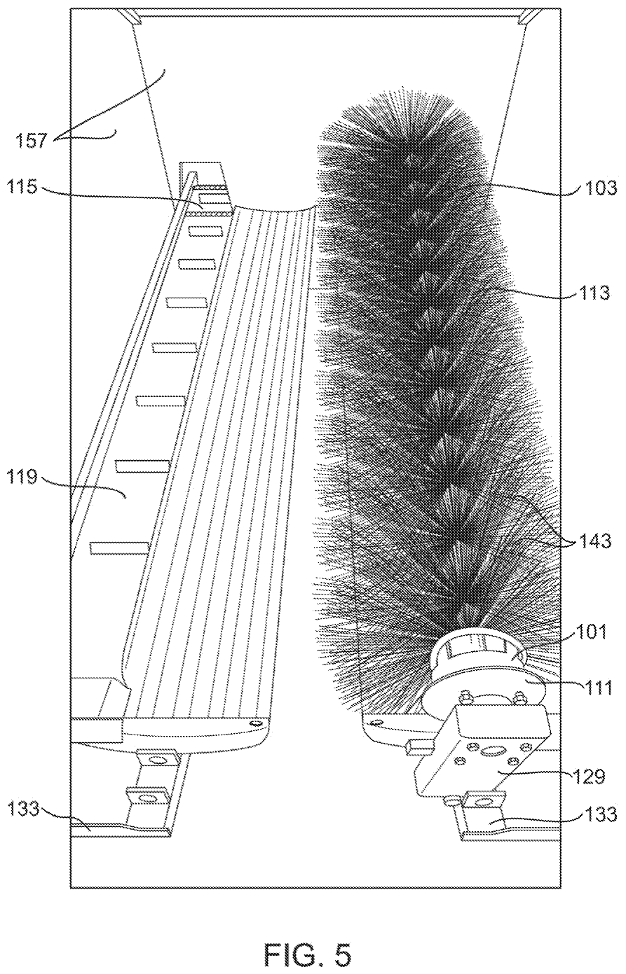

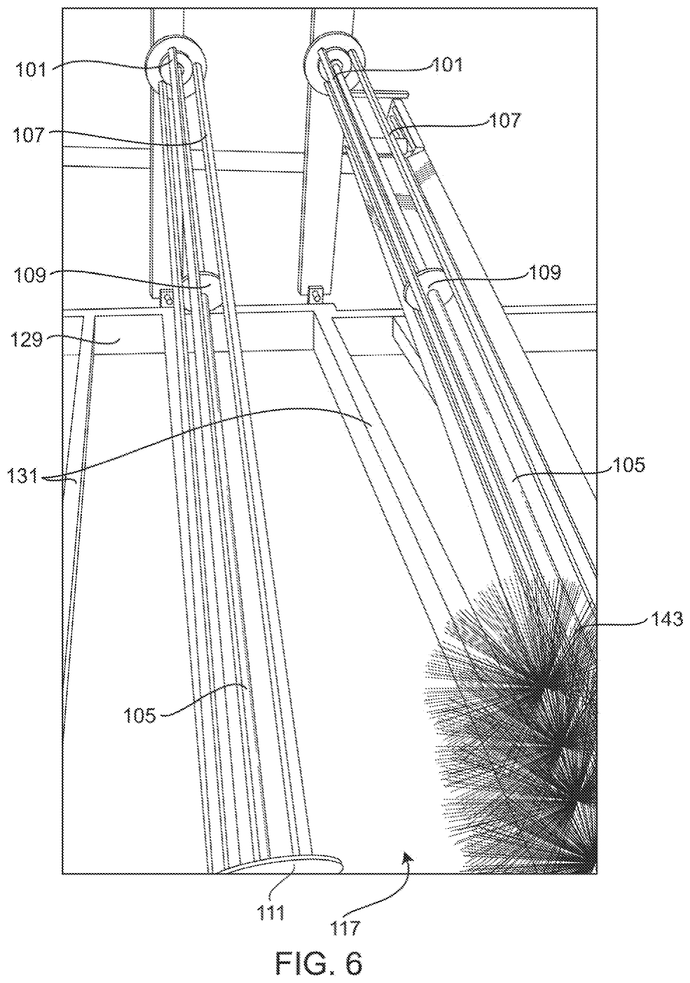

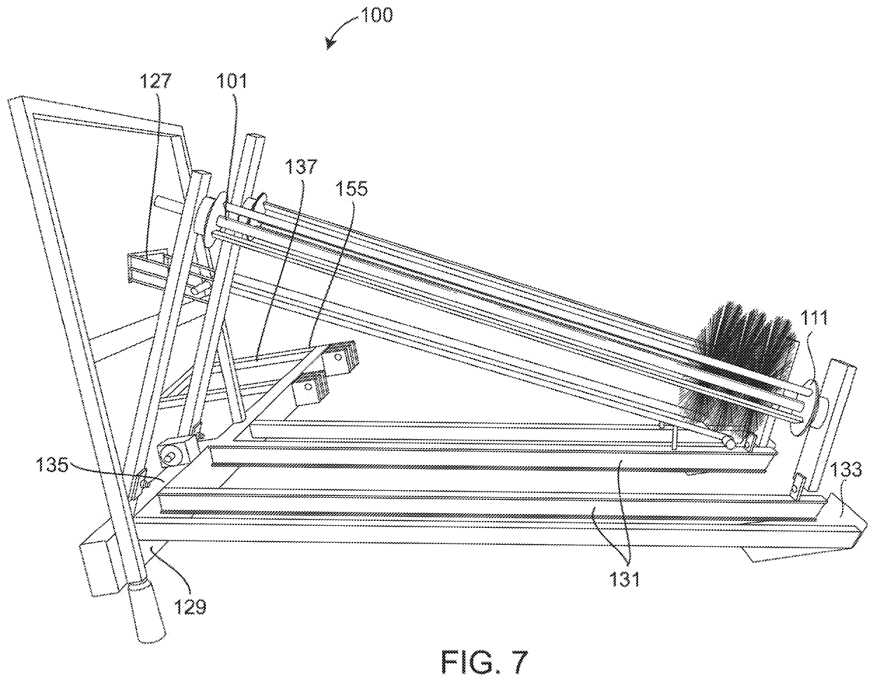

FIGS. 1-7 provide for a number of views of a first embodiment of a Cannabis harvester. FIG. 1 depicts a front perspective view of the first embodiment of a Cannabis harvester as contemplated herein, which is connected to an exemplary tractor. FIG. 2 depicts a rear view of the embodiment of the Cannabis harvester depicted in FIG. 1. FIG. 3 depicts an additional front perspective view of the embodiment of the Cannabis harvester depicted in FIG. 1. FIG. 4 depicts a front perspective view of an embodiment of a harvesting section of the embodiment of the Cannabis harvester depicted in FIG. 1. FIG. 5 depicts additional details of the embodiment of a harvesting section of the embodiment of the Cannabis harvester depicted in FIG. 4. FIG. 6 depicts additional details of the embodiment of a harvesting section of the embodiment of the Cannabis harvester depicted in FIG. 4 with the enclosure portion, brushes, and harvester conveyers removed. FIG. 7 depicts additional details of the embodiment of a harvesting section of the embodiment of the Cannabis harvester depicted in FIG. 4 with the most of the enclosure portion, brushes, and harvester conveyers removed.

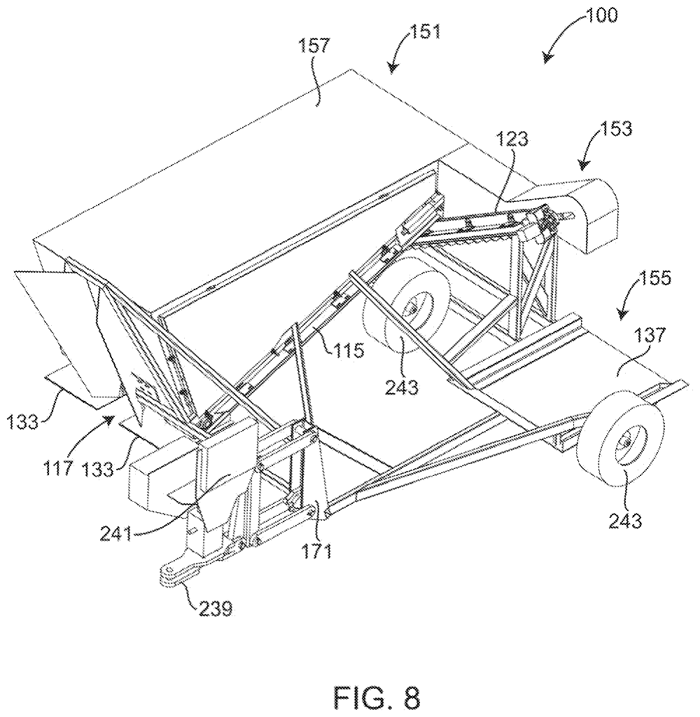

FIG. 8 provides a perspective view of a second embodiment of a Cannabis harvester with the hopper removed. This second embodiment is designed to have a pull type connection to the tractor instead of the 3-point mount shown in the first embodiment and is designed to have its hydraulic pump run off the tractor's Power-Take-Off (PTO). Operationally, the harvesting section of the embodiment of FIG. 8 may operate in the same or similar manner to the embodiment of FIGS. 1-7. This second embodiment, however, allows for use with different types of tractors and for different operation depending on user's needs.

The overall shape of the Cannabis harvester (100), as depicted, is that of an “L”, or a right-angled concave hexagon. As depicted, the Cannabis harvester (100) includes a frame (129) that supports two rollers (101), although in FIGS. 1 and 3-5 only one roller (101) is installed. FIGS. 6 and 7 depict two rollers (101). Additionally, the frame (129) may be used to support the other various portions of the Cannabis harvester (100). In the depicted embodiment, the Cannabis harvester (100) includes a frame (129) made of connected lengths of supporting material. The supporting material may be any material, including without limitation a metal material, such as steel. Like the overall shape of the Cannabis harvester (100), the overall shape of the frame (129), as depicted, may be that of an “L” or a right-angled concave hexagon.

In the depicted embodiment, the frame (129) comprises several different section including a harvesting section (151), a connecting section (153), and a collecting section (155). The harvesting section (151) of the frame (129) may include two leg portions (131), two skid pads (133), and a plurality of vertical portions, which may serve to support the rollers (101) and/or harvester conveyers (115). The connecting section (153) of the frame may include a connecting support (135). The collecting section (155) may include a collector support (137), and in some embodiments, a motor support (not depicted). The harvesting section (151), in the depicted embodiment, is connected to the collecting section (155) via the connecting section (153). As used herein, the term “front” will refer to the side of the Cannabis harvester (100) that is toward the tractor (200) in normal operation and as depicted in FIG. 1. Further, the term “back” will refer to the opposing side of the Cannabis harvester (100).

For the harvesting section (151), two leg portions (131) may be included as apart of the frame (129). Each leg portion (131) of the frame (129) may support one roller (101) and one harvester conveyer (115). In the depicted embodiment, each leg portion (131) may be formed generally in the shape of a rectangular prism and essentially framed by supporting material. Each leg portion (131) may be generally planar with the other leg portion (131). In other embodiments, alternative structures for supporting the rollers (101) and the harvester conveyers (115) may be used.

In the depicted embodiment, one end of each leg portion (131) may be connected to the connecting support (135). At the other end of each leg portion (131), a skid pad (133) may be included. As shown in FIG. 8. The leg portion (131) or other portions may be mounted on wheels (243) to facilitate support and movement of the harvester (100). The skid pad (133) may be used to allow that end of the leg portions (131) to be positioned close to or on the ground during operation. In such an embodiment, the skid pads (133) may provide a lower friction surface, and further, may protect the frame (129) from damage caused by interacting with the ground. The skid pads (133) may be made from any material, including without limitation a metal material, such as steel. In other embodiments, the skid pads (133) may be replaced or supplemented with wheels, rollers, or other devices known in the art to provide a low friction contact point. In the depicted embodiment, each leg portion (131) may be generally parallel to the other leg portion (131). In other embodiments, the two leg portions (131) may be formed at an angle relative to each other.

Any number of vertical portions of the frame (129) may support the rollers (101) and the harvester conveyers (115). In the depicted embodiment, a shorter vertical portion of the frame (129) may support the end of each roller (101) towards the end of the frame leg portion (131) closest to the related skid pad (133). Further, a taller vertical portion of the frame (129) may support the end of each roller (101) towards the end of the frame leg portion (131) closest to the connecting support (135). Thus, the rollers (101) may be arranged at an inclined angle relative to the generally parallel plane shared by the leg portions (131). In other embodiments, the arrangement of the rollers (101) may be an alternative arrangement. The harvester conveyers (115) may also be attached to the frame (129) in a similar manner, using the same vertical portions of the frame (129) as the rollers (101), using different vertical portions of the frame (129), or using one or more alternative supports.

On the side of the connecting support (135) of the frame (129) opposite to the harvesting section (151) and leg portions (131) may be the collecting section (155) and collector support (137) of the frame (129). The collector support (137) may be configured to support one or more hoppers (125). In some embodiments, a motor support may be located toward this side of the connecting support (135) in the collecting section (155). The motor support may hold or carry one or more motors (not depicted). In some embodiments, more than one collector support (137) may be included. The collector support (137) and motor support may be separate from each other or integrated together.

The rollers (101) that are carried by the harvesting section (151) may be used as a frame and support for brushes (103) and as a means for rotating the brushes (103). Although two rollers (101) are depicted in FIGS. 6 and 7, in other embodiments, more or less rollers (101) may be used. A roller (101) may be made from any material capable of withstanding the forces involved with Cannabis harvesting. For example, the roller (101) may be made from a metal material, such as steel. As depicted, the rollers (101) each have an overall generally cylindrical shape. Each roller (101) may include a central shaft (105) and four outer supports (107). One or more spacers (109) may be formed between the central shaft (105) and the outer supports (107), which spacers (109) may assist in limiting the overall movement of the outer supports (107), for example, during operation of the Cannabis harvester (100). In other embodiments, the rollers (101) may be any shape or size, and the rollers (101) may include any number of central shafts (105), axles, and/or outer supports (107). In some other embodiments, the rollers (101) may have a generally tubular construction. In yet some other embodiments, the rollers (101) may be formed as a solid rod. In any case, each roller (101) will be capable of rotating around an axis. Typically, the axis of rotation will be the major axis of the roller (101). The bases (111) of each roller (101) may be formed as a solid plate, or any other shape. The bases (111) may be used to connect the rollers (101) to other portions of the Cannabis harvester (100). The area between the rollers (101) will be referred to in this application as the harvesting space (117) as this is typically where harvesting of plants will occur.

Each roller may include a brush (103). A brush (103) is typically a collection of bristles (113) that are formed into a shape having the general appearance of a disk or a cylinder. In the depicted embodiment, a brush (103) may be mounted onto each roller (101). In other embodiments, a brush (103) may be otherwise attached to the roller (101). In yet other embodiments, the roller (101) and brush (103) may be integrated as a single unit. The brush (103) may have any number of bristles (113) that extend away from the major axis of the roller (101). The bristles (113) may be formed of one or more of nylon, polypropylene, metal (steel or other), natural fibers (for example, istle and/or Palmyra fibers), and any other material. The brush (103) may extend for any length of the roller (101). In the depicted embodiment, the brush (103) extends for almost the entire length of the roller (101). Each brush (103) may be formed as a single brush unit, or, as shown in FIGS. 1 and 3-5, as a collection of multiple units called brush segments (143). The brush segments (143) may have any size or shape. Each brush segment (143) may be the same, or some or all of the brush segments (143) may be different from each other. Together, the brush segments (143) may act as a single brush (103). In some embodiments, the brush segments (143) on adjacent rollers (101) may be offset from one another. Further, the bristles (113) of the brush segments (143) on adjacent rollers (101) may overlap to some extent. In other embodiments, the brush segments (143) on adjacent rollers (101) may be aligned, and/or the bristles (113) of the brush segments (143) on adjacent rollers (101) may not overlap.

The rollers (101), including their brushes (103), may be used to remove the buds and leaves from Cannabis plants. For example, in the embodiments depicted in the FIGS., the rollers (101) may be rotated in opposing directions, for example, where the direction of rotation will have a tendency to send any harvested plant matter between the two rollers (101) up and over one of the two rollers (101). In the depicted embodiment, the roller (101) on the left, which is labeled (“A”), would rotate counter-clockwise as viewed from the front, and the roller (101) on the right, which is labeled (“B”) would rotate clockwise as viewed from the front. The rollers (101) may be arranged generally parallel to each other, or may be otherwise angled relative to each other to provide differences in space between them at the front compared to the back. As the brushes are typically angled upward from the front to the back, this can be used to provide a different amount of space in the harvesting space (117) depending on the height of the Cannabis plant interacting with the brushes. For example, the rollers (101) may be closer together toward the top part of the Cannabis plant compared to the bottom.

In the depicted embodiment, two harvester conveyers (115) may be used to transport harvested buds and leaves from the rollers (101) towards the back of the Cannabis harvester (100). For any given roller (101), a harvester conveyer (115) may be located toward the side of the roller (101) that is opposite to the harvesting space (117). In the depicted embodiment, one harvester conveyer (115) is located toward the side of the left roller (101A) opposite to the harvesting space (117). The other harvester conveyer (115) is located toward the side of the right roller (101B) opposite to the harvesting space (117). In other embodiments, the harvester conveyers (115) may be located in different locations than what is depicted in the FIGS.

In the depicted embodiment, one or more collecting conveyers (123) may also or alternatively be used. The collecting conveyer (123) may be used to transport harvested buds and leaves from the harvester conveyers (115) towards a hopper (125). The collecting conveyer (123) may be formed at a lower height than the ends of the harvester conveyers (115) so that harvested buds and leaves may fall from the ends of the harvester conveyers (115) onto the collecting conveyer (123). In some embodiments, an enclosure portion (157) may be used to enclose at least a portion of the rollers (101) and/or harvester conveyers (115). Such an enclosure portion (157) may be oriented and/or arranged such that any Cannabis material that is harvested by the rollers (101) and brushes (103) will not be thrown from the Cannabis harvester (100), but will be retained and funneled towards the harvester conveyers (115) for subsequent collection. The enclosure portion (157) may include a top portion or may have an open top. The enclosure portion may be made from any material, for example, from a metal, such as steel.

In yet other embodiments, the collecting conveyer (123) and/or harvester conveyers (115) may be replaced with any system known in the art that is capable of conveying plant material from one location to another. Each of the collecting conveyer (123) and the harvester conveyers (115) may be made from any materials known in the art to be suitable for forming belt or chain conveyer systems. For example, the collecting conveyer (123) and harvester conveyers (115) may include metal frames (not depicted) and rubberized belts (119). The collecting conveyer (123) and harvester conveyers (115) may be driven by one or more onboard motors. In some embodiments, a single motor may drive all of the collecting conveyer (123) and the harvester conveyers (115). In other embodiments, two or more motors may drive the collecting conveyer (123) and/or harvester conveyers (115), independently or in tandem. Alternatively, such as in the embodiment of FIG. 8, the motor may be replaced or supplemented by a hydraulic power system (241) which may be utilized in conjunction with the Power-Take-Off (PTO) from an attached tractor (200) or other vehicle.

Each of the collecting conveyer (123) and the harvester conveyers (115) may include a conveyer belt tensioner (127). Each belt tensioner (127) may be capable of adjusting the tension of the related belt on the relevant collecting conveyer (123) or harvester conveyer (115). In the depicted embodiment, each belt tensioner (127) may include a belt frame that is attached at the end of a given belt conveyer, typically at an end roller of the support structure for the belt conveyer. Both ends of the end roller of the belt conveyer may be mounted onto tracks formed within the belt frame via blocks. Bolts then may be used to position the blocks and the related end roller of the belt conveyer along the tracks, which may assist in tensioning the conveyer belt. In other embodiments, any apparatus for tensioning belts on belt conveyers may be used.

FIGS. 1-4 depict an embodiment of a Cannabis harvester (100) connected to a tractor (200). In the depicted embodiment, the Cannabis harvester (100) is intended to be used in conjunction with a machine that will carry and/or move the Cannabis harvester (100) as it is used, for example, to harvest Cannabis plants. In some other embodiments, the Cannabis harvester (100) may be capable of being used by a combine or other mechanized agricultural machinery. In the depicted embodiment, the rollers (101) may be connected to the engine or other power source of the tractor (200) so that the rollers (101) may be rotated. In other embodiments, the one or more motors may be used to rotate the rollers (101). The Cannabis harvester (100) may be connected to the tractor (200) using any method known in the art. In the depicted embodiment of FIGS. 1-7, the Cannabis harvester (100) may include a three point mount or coupler (139) for attaching to the tractor's three point hitch system, as would be understood by persons of ordinary skill in the art. In the embodiment of FIG. 8, the three point coupler (139) is replaced by a pull type trailer coupler (239) to connect to a trailer hitch (such as a ball hitch—not shown) on the tractor (200). In other embodiments, any system known to persons of ordinary skill in the art for attaching equipment to vehicles may be used.

In some embodiments, a positioning holder (171) may be included in the connection between the (200) and the Cannabis harvester (100). In some embodiments, the positioning holder (171) may be a hydraulic cylinder. In any case, the positioning holder (171) may be used to adjust the front height of the Cannabis harvester (100) up and down, or otherwise adjust the orientation of the Cannabis harvester (100). Such a system may allow a user to control the front height of the Cannabis harvester (100) to get as low as possible to the ground without digging in the dirt and/or having the Cannabis harvester (100) too high where buds and/or leaves may be left unharvested on the bottom stalks of Cannabis plants being harvested.

When in use, the Cannabis harvester (100) may be carried and/or moved by the tractor (200). As the tractor (200) moves forward, the Cannabis harvester (100), as depicted, may move along with the tractor (200), adjacent one side and the rear of the tractor (200) as shown in FIGS. 1-4 or more to the rear of the tractor (200) with the embodiment of FIG. 8. The tractor (200) may then be driven alongside rows of Cannabis, such that each plant within a row of Cannabis to be harvested may be fed into the harvesting space (117) between the two leg portions (131) of the frame (129). The tractor (200) or other power source may begin the process of rotating the rollers (101) and related brushes (103) just before beginning to harvest the Cannabis. Further, the harvester conveyers (115), and collecting conveyer (123) may be powered up.

In an embodiment, the rollers (101) may be rotated at a speed between about 100 rpm and about 500 rpm. In other embodiments, the rollers (100) may be rotated at a speed of about 300 rpm. In an embodiment, the amount of torque applied may be between about 1000 in/lbs. and about 3000 in/lbs. In other embodiments, the amount of torque applied may be between about 2000 in/lbs.

When Cannabis plants are introduced into the harvesting space (117), the rotating brushes (103) may strip the buds and leaves off the Cannabis plants and may leave the stalks of the plants standing in the field. When stripped by the brushes (103), the buds and leaves may be deposited onto one of the harvester conveyers (115). The harvester conveyers (115) may then transport the buds and leaves to the collecting conveyer (123). The collecting conveyer (123) may then transport the buds and leaves to the hopper (125) for temporary storage. Once the hopper (125) is sufficiently full, the hopper (125), in an embodiment, may be removed and emptied, and that hopper (125) or another hopper (125) may be placed onto the platform of the collector support (137) through any means known to one of ordinary skill in the art. Once the harvesting is finished, the rollers (101), harvester conveyers (115), and collecting conveyer (123) may be powered down.

Subsequent to collection, the harvested buds and leaves may be further processed. For example, the buds and leaves may be separated for further processing separate from each other. Alternatively, the buds and leave may be processed together. The buds and/or leaves may be dried for further processing. Another further processing step may be to press either dried or wet buds and/or leaves to extract their internal oils and other products. In any case, the buds and/or leaves will typically be further processed after being collected by the Cannabis harvester (100).

Accordingly, the Cannabis harvester (100) may allow for efficient, mechanized harvesting of the buds and leaves of Cannabis. In other embodiments, the Cannabis harvester (100) may be used to harvest other agricultural crops, such as, for example, flax. In some embodiments, the Cannabis harvester (100) may knock down the standing Cannabis stalks after they have been stripped of leaves and buds or may include a stalk cutter specifically for this purpose. Such a stalk cutter may include a saw, a chain saw, a blade, and/or a plow to uproot or cut the stalks of the Cannabis plants after the buds and leaves have been harvested. In some embodiments, these stalks may be collected or further processed by the Cannabis harvester (100) utilizing another collection mechanism. In other embodiments, the stalks may simply be removed from the ground and laid wherever they fall after removal for later collection. In yet other embodiments, the stalk cutter may be a follow-on machine that is separate from the Cannabis harvester (100) and is used to harvest the stripped Cannabis stalks.

The Cannabis harvester (100), in an embodiment, may be used to simplify and/or improve the harvesting of Cannabis plants for hemp. For example, the Cannabis harvester (100) may be used to remove unwanted buds and/or leaves from the stalk of the hemp plants being harvested. Then the Cannabis harvester (100) or a simpler follow-on machine may cut or otherwise remove the hemp stalks from the ground. The Cannabis harvester (100) may be configured in such an embodiment to remove the buds and leave from the stalk of the hemp plants and then leave the buds and leaves in the field without collection. This may be accomplished by modifying the harvester conveyers (115) and/or collecting conveyer (123) so that the buds and leaves transported by the conveyers will be deposited into the related field and not into a hopper (125).

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “parallel” and “cylindrical” are purely geometric constructs and no real-world component is a truly “parallel” or “cylindrical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A Cannabis harvester comprising:
a first roller having a brush thereon, said first roller rotating in a first direction and having a first harvester conveyor associated therewith;
a second roller having a brush thereon, said second roller rotating in a second direction opposing said first direction and having a second harvester conveyor associated therewith;
a collecting conveyor configured to collect material from at least one of said first harvester conveyor and said second harvester conveyor and transport said material to a hopper; and
a collector support configured to support said hopper.

2. The harvester of claim 1 further comprising a coupler for connecting said harvester to a vehicle.

3. The harvester of claim 2 wherein said vehicle is a tractor.

4. The harvester of claim 2 wherein said coupler is a three point mount coupler.

5. The harvester of claim 2 wherein said coupler is a ball mount coupler.

6. The harvester of claim 2 wherein said vehicle is a combine.

7. The harvester of claim 2 wherein said first roller, said second roller, said first harvester conveyor, said second harvester conveyor, and said collecting conveyor are powered by a Power-Take-Off (PTO) from said vehicle.

8. The harvester of claim 1 wherein said first roller and said second roller are within an enclosure.

9. The harvester of claim 8 wherein said first harvester conveyor and said second harvester conveyor are within said enclosure.

10. The harvester of claim 1 wherein said first roller, said second roller, said first harvester conveyor, said second harvester conveyor, and said collecting conveyor are powered by a motor on said Cannabis harvester.

11. A method of mechanically harvesting Cannabis, the method comprising:
introducing a standing Cannabis plant to a harvesting space, said harvesting space being located between a first roller having a brush thereon and a second roller having a brush thereon;
rotating said first roller in a first direction;
rotating said second roller in a second direction opposing said first direction;
said rotating of said first roller and said second roller causing said brush on said first roller and said brush on said second roller to strip leaves and buds from a stalk of said Cannabis plant and deposit said leaves and buds onto at least one harvester conveyor;
said at least one harvesting conveyor transporting said leaves and buds to a collecting conveyor, said collecting conveyor transporting said material to a hopper.

12. The method of claim 11 wherein said stalk is left standing after said stalk is stripped of said leaves and buds.

13. The method of claim 11 wherein said introducing is caused by a vehicle moving said first roller and said second roller to said standing Cannabis plant.

14. The method of claim 13 wherein said vehicle is a tractor.

15. The method of claim 13 wherein said vehicle is a combine.

16. The method of claim 13 wherein said first roller, said second roller, said at least one harvester conveyor, and said collecting conveyor are powered by a Power-Take-Off (PTO) from said vehicle.

17. The method of claim 1 wherein said harvesting space is within an enclosure.
